(19) United States
(12) Patent Application Publication
(10) Pub. No.: US 2023/0272583 A1
(43) Pub. Date: Aug. 31, 2023

(54) DEVICE AND METHOD FOR DAMPENING A MATERIAL WEB

(71) Applicant: Voith Patent GmbH, Heidenheim (DE)

(72) Inventors: Andreas Haux, Heidenheim (DE); Frank Wegehaupt, Heidenheim (DE); Jörg Spindler, Schäbisch Gmünd (DE)

(73) Assignee: Voith Patent GmbH, Heidenheim (DE)

(21) Appl. No.: 18/311,917

(22) Filed: May 4, 2023

Related U.S. Application Data
(63) Continuation of application No. PCT/EP2021/079069, filed on Oct. 20, 2021.

(30) Foreign Application Priority Data
Nov. 5, 2020 (DE) 10 2020 129 160.4

(51) Int. Cl. D21G 7/00; D21F 7/00; F16K 31/06

(52) U.S. Cl. CPC D21G 7/00; D21F 7/008; F16K 31/0655

(57) ABSTRACT

A method for at least one of regulating and controlling at least one dampening device suitable for dampening a material web, the method comprising the steps of: providing that the dampening device includes a valve which includes at least one electromagnetic force transmitter, a reset force transmitter, a valve body, the dampening device further including a control unit and an application nozzle; and performing, by the dampening device, a cleaning cycle, the valve being a proportional valve, the proportional valve pulsing about a set target value, a deviation from the set target value occurring by way of a timing such that the deviation from the set target value results, the deviation being at least one of a positive deviation and a negative deviation.

### CROSS REFERENCE TO RELATED APPLICATIONS

This is a continuation of PCT application no. PCT/EP2021/079069, entitled “DEVICE AND METHOD FOR DAMPENING A MATERIAL WEB”, filed Oct. 20, 2021, which is incorporated herein by reference. PCT application no. PCT/EP2021/079069 claims priority to German patent application no. 10 2020 129 160.4, filed Nov. 5, 2020, which is incorporated herein by reference.

### BACKGROUND OF THE INVENTION

### 1. Field of the Invention

The invention relates to a method for regulating and/or controlling at least one dampening device, including a valve with at least one electromagnetic force transmitter as well as a reset force transmitter, a valve body, a control unit, as well as an application nozzle, suitable for dampening a material web, in particular a paper, cardboard or fibrous web.

The invention moreover relates to a dampening device and to the use of a dampening device for defined dampening of a paper, cardboard, tissue, or another material web in a machine for the production and/or conversion of said web.

### 2. Description of the Related Art

The material web is dampened to set the defined final dry content or to change quality properties such as dimensional stability (“curl”). The material web may also be dampened in order to compensate for local moisture differences. A uniformity of the moisture across the width of the paper web can be achieved in particular by way of a plurality of dampening devices which are arranged distributed over the width of the material web. The terms “profiling” or “transverse profiling” are also used in literature describing the process of regulating moisture across the width of the material web, as for example in DE 102007025611 A1.

A dampening device is also known from the current state of the art, described in DE 42 33 992 A1.

Dampening is herein achieved via nozzles which apply an application medium such as water or a water/steam mixture to the paper web. The water may consist of different qualities, for example fresh water, condensate, clear filtrate or process water of a higher quality. Since dirt, solids or fibers can also get into the nozzle and the valve body via the application medium, problems are often associated with ensuring uniform operation and precise control of the dampening device.

Particular attention is therefore given in the state of the art to the control valve and the application nozzles. EP1088594B1 describes the control of the application volume by way of a pulsation valve. The pulsation valve is controlled in a binary manner via pulsation. This means simply that it is operated in the open and closed states. This means that the application volume is controlled via the time sequence of open and closed valve states by way of pulsations. Subsequently, the pulsations are then balanced by a damping element in order to obtain a uniform volume flow of the application medium.

The advantage of pulsation valves is that the motion drives the valve body to a stop, which can typically be implemented at high speed and force. Thus, clogging of the valve, especially due to deposits or contamination, is very rare. Pulsation valves are also usually moved steadily and quickly.

The disadvantage of pulsation valves, also called timed valves has hitherto been the additional effort required to compensate for the resulting fluctuations in the application rate. This can occur through downstream damping elements, or by using a plurality of valves arranged respectively in a parallel arrangement or series connection, thereby achieving a balanced volume flow.

With the low application volumes for web dampening and the steady modes of operation proportional valves have not been used hitherto in the state of the art for web dampening because of the tendency of clogging due to deposits or contamination. Moreover, conventional proportional valves are often not able to ensure the required rapid adjustment of the dampening volume. In the case of slow adjustment, incorrect moisture values can occur locally in the material web, which can no longer be compensated for over time and which lead to quality problems in the web.

What is needed in the art is to combine the advantages of proportional valves for precise control of the application volume for dampening of a material web with the advantages of rapid pulsation valves in order to avoid the aforementioned disadvantages.

### SUMMARY OF THE INVENTION

The present invention provides a method wherein the dampening device can conduct a cleaning cycle wherein the valve is designed as a proportional valve, wherein the proportional valve pulses about the set target value, wherein the deviation from the set target value occurs by way of timing so that a positive and/or a negative deviation from the target value results.

The momentary pulsation in the cleaning cycle has the advantageous effect of loosening deposits and contaminations that can adhere to the valve body or the application nozzle, thus preventing clogging of the application nozzle. The application nozzle can also be designed as an application opening. Furthermore, application nozzles or application openings can also include a ceramic insert to additionally minimize wear and/or contamination.

Advantageously, at least one dampening device, including a valve with at least one electromagnetic force transmitter as well as a reset force transmitter, a valve body, and a control unit as well as an application nozzle or application orifice, suitable for dampening a material web, in particular a paper, cardboard or fibrous web, is provided, wherein the valve is a proportional valve and has a control range which can be set to a target value in at least 25 steps, optionally at least 100 steps.

The proportional valve differs from a pulsation valve by providing the possibility of allowing different target values in the range between the closed and the open state of the valve body. In comparison, a pulsation valve only enables the two states open and closed. The target value refers to a variable defined volume flow that can pass through the valve at a partial opening. Since valve opening and flow rate or, respectively, volume flow are directly dependent variables, it is irrelevant whether the target value is defined as valve position or application volume.

By changing the force that can be applied to the valve body by the electromagnetic force transmitter, the desired target value can be set here.

The control unit for the dampening device can receive a command or signal to change the valve position, for example, in the form of an electrical signal from a higher-level control system, process control, closed-loop control, or as direct manual user input. According to the specification, the control unit can then be used to change the electric current or voltage for the electromagnetic force transmitter so that the desired target value can be set. To achieve rapid control, the control unit operates at a high operating frequency at which signals can be processed and changed. This is typically done with an operating frequency greater than 100 Hz, optionally greater than 1 kHz, and in particular greater than 1 Mhz.

The dampening device is also advantageous after a demand, when the proportional valve includes a valve body, wherein the valve body traverses a distance of less than 5 mm from Closed to Open, optionally less than 2 mm.

The described distance is the controlled system distance that the valve body can travel, whereby the volume flow passing through the valve is changed in proportion to the controlled system distance. A short controlled system distance is advantageous herein, since only a short distance has to be covered between different target values. Therefore, the short distance enables a correspondingly rapid response of the valve. In laboratory tests, valves were tested with a distance of less than 2 mm and even with a distance of less than 1 mm. It is herein important that a high resolution of intermediate steps remains possible in order to enable precise control of the application volume.

Also advantageous is a dampening device wherein the electromagnetic force transmitter or transmitters is/are suitable to fully open or close the proportional valve from any target value in a time of less than 0.3 seconds, optionally less than 0.1 seconds.

A rapid response of the proportional valve enables uniform dampening of the material web since small changes in the application volume can equalize themselves later in the paper, if only smaller differences are to be equalized.

Also advantageous is a dampening device wherein the electromagnetic force transmitter is suitable to adjust the proportional valve to any target value in a time of less than 0.3 seconds, optionally less than 0.1 seconds.

When production conditions change, it is also important that the dampening device can respond quickly in order to quickly compensate for local differences in moisture conditions. Appropriate dampening control based on a measured final moisture can also help to improve paper quality and moisture by providing a rapid valve response.

Also advantageous is a dampening device, wherein the proportional valve is directly followed by the nozzle or the application orifice, and no additional functional elements are used, in particular for pulsation damping.

An advantageous embodiment of the invention is provided if the expensive and failure-prone pulsation dampers which—in the current state of the art—are used after pulsation valves or cycled valves can be dispensed with.

A functional element is herein, for example, a pulsation damper that causes pressure equalization by way of an elastomer, spring element or compressible gas. Pipelines and (manual) shut-off valves, which are used for example for maintenance work are not functional elements in the sense of the present invention.

Also advantageous is a dampening device, wherein the reset force transmitter in the proportional valve may include a mechanical spring element, a magnetic or electromagnetic force transmitter, or a pneumatic force transmitter.

A spring element can be any type of mechanical spring, such as a metal spring, a spring washer or an elastomer or similar material that can exert a spring force due to its material properties.

Also advantageous is a method for regulating and/or controlling at least one dampening device for dampening a material web, in particular a paper, cardboard or fibrous web, wherein the moistening device can perform a cleaning cycle in which the proportional valve pulses about the set target value, wherein the deviation from the set target value occurs by way of timing so that a positive and/or a negative deviation occurs, wherein the deviation is advantageously at least of similar length, optionally of equal length.

The objective of the method is to keep the volume of application medium constant at the target value over the time average as far as possible. Pulsing is to be understood as a short movement of the valve body on the controlled system distance which first deviates positively then negatively from the target value or respectively, initially negatively and then positively.

If the target value is a completely, or extensively open valve (˜100%), the cleaning cycle can only be accomplished by a partial short closure; a short-term slight drop in the volume of application medium over time cannot then be avoided but is also part of the present invention.

This also applies if the valve position is fully closed (˜0%). In this case too, the cleaning cycle can only be performed by briefly opening the valve, which results in a brief slight increase in the volume of application medium. In both these cases (closed or open), pulsing is to be understood as a brief deviation in only one direction from the target value.

Also advantageous is a method, wherein the dampening device includes a proportional valve that can be opened or closed at least partially, pulsating rapidly about the set target value, wherein the deviation from the set target value lasts less than 0.3 seconds optionally less than 0.1 seconds, and the pulsating can be repeated.

Also advantageous is a method, having at least two, optionally more than three, dampening devices, wherein a dampening device pulsating in a cleaning cycle is arranged adjacent to at least one other dampening device capable of performing pulsation in an opposite direction.

In this embodiment, a dampening device has a plurality of application nozzles arranged across the width of the paper web in order to compensate for differences in dampening across the width of the paper web. The cleaning cycle is then not conducted simultaneously on all dampening devices, but instead only on individual ones, wherein the respectively adjacent nozzles can pulsate in opposite direction. Each application nozzle applies moisture to the material web in a spray cone configuration, and the spray cones are usually arranged to overlap those of adjacent nozzles to provide uniform moistening. Short-term differences in the dampening of the material web can thus be effectively compensated for by adjacent nozzles.

Also advantageous is a method, having at least two, optionally more than three, dampening devices, wherein the opposite pulsation may exhibit only half the amplitude or time duration of the deviation from the set target value.

The cleaning cycle can thus be performed on individual nozzles from the plurality of nozzles arranged across the web width. The aim of the opposite pulsation of the adjacent moistening devices with half the amplitude is herein also a uniform dampening of the material web. Thus, balancing of the dampening device in the cleaning cycle can be achieved by way of the adjacent dampening devices.

Also advantageous is a method wherein the cleaning cycle and/or the pulsation deviates only in one direction from the target value, wherein the cleaning cycle (12) and/or the pulsation can also be started with fully closed or fully open valve.

In order to perform a cleaning cycle and/or pulsation even in the event of a closed valve of the dampening device, it is necessary for it to be opened briefly. In this case, there is no possibility of fluctuation around the target value; only pulsation into the open state is provided. Similarly, even with a fully open valve, pulsation can only occur in an at least partially closed state.

Also advantageous is a method, wherein pulsing or the cleaning cycle is optionally performed at a time when a material web of reduced quality is being produced, or when a machine for producing said material web is in a specific operating state.

The frequency at which the cleaning cycle and pulsing are necessary to prevent the valve bodies from seizing up can vary greatly, as various influencing factors can lead to sticking, for example:
Water quality, in particular dissolved solids and contaminants;
Flow rates and contingent nozzle geometry and valve geometry
(larger valves and nozzles tend to seize up in practice);
Thermal changes in the dampening device and application medium.

Accordingly, depending on the particular embodiment of the present invention, it may be necessary for the valve body to be in constant or near constant motion by way of pulsation or the cleaning cycle, or in another embodiment, to be moved only a few times per day. In that embodiment, it is advantageous to perform the pulsation or the cleaning cycle, for example, during a web break, grade change, cleaning downtime, or during the start-up after a downtime since this prevents moisture differences from entering the saleable material web.

Also advantageous is the use of at least two dampening devices, wherein a plurality of dampening devices are arranged over the width of the material web, which are suitable for applying different moistening levels to different zones. This arrangement is also known in the paper industry as a nozzle dampening device.

The moisture content of the cross-profile of the paper web can be controlled via the plurality of dampening devices. Typically, 20 to 200 dampening devices can be arranged over the web. Thus, a zone width of 5 cm to 50 cm can be achieved; especially advantageous is a zone width for a single dampening device of 5 cm to 20 cm.

Additional advantageous variations of the invention are explained with reference to the drawings on the basis of embodiment examples. The described characteristics can be advantageously implemented not only in the combination shown but can also be combined individually with one another.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic partial representation of a possible embodiment of a dampening device for moistening a material web in a sectional view;

FIG. 2 a schematic characteristics curve to explain the control range for the application volume in the method according to one claim of the invention; and

FIG. 3 a schematic partial representation of one possible embodiment of a method and a device of the invention.

Corresponding reference characters indicate corresponding parts throughout the several views. The exemplification set out herein illustrates at least one embodiment of the invention, and such exemplifications are not to be construed as limiting the scope of the invention in any manner.

### DETAILED DESCRIPTION OF THE INVENTION

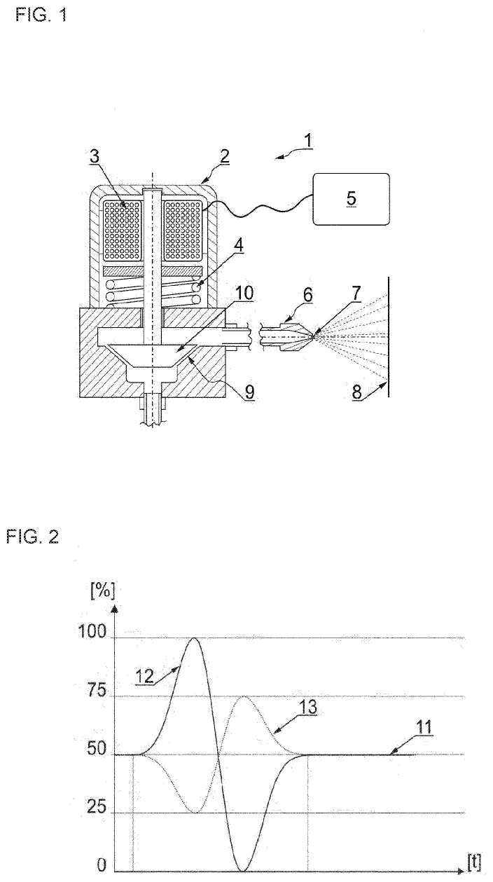

FIG. 1 shows a schematic partial representation of a possible embodiment of a dampening device 1. Dampening device 1 includes a proportional valve 2 with an electromagnetic force transmitter 3 and a reset force transmitter 4, which are capable of moving a valve body 10 within a control range 9. The valve body is controlled or regulated to the target value by control unit 5. The controlled volume flow of the application medium is then sprayed onto a material web 8 by way of an application nozzle 6 or application orifice 7, wherein the application nozzle is shaped having a tapering cross-section. Due to the high shear forces at application orifice 7, the emerging liquid is atomized into small droplets which allow uniform moistening of material web 8.

FIG. 2 shows a schematic partial representation to explain the control range for the application volume in the method according to the present invention. The control range is shown on the vertical axis as a percentage value of the valve opening or application volume. The horizontal axis relates to time [t]. A pulsation movement is shown with a cleaning cycle 12. Opposite pulsation 13 shows the inversely proportional opening of the adjacent valves, each of which in this application example deviate from target value 11 by only half the amplitude of cleaning cycle 12. Target value 11 in this example is shown as 50% of the possible valve opening or application amount.

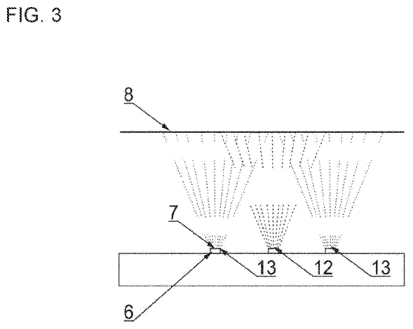

FIG. 3 shows a schematic partial representation in a top view of a possible embodiment of a method of the present invention. Several application nozzles 6 with corresponding application orifices 7 are shown, which are arranged adjacent to one another across the width of material web 8. The sprayed-on application medium is shown schematically by dotted lines. The center nozzle is currently running through a cleaning cycle 12, while the two adjacent nozzles perform an opposite pulsation 13. In this way, material web 8 is dampened at a largely constant average rate. If cleaning cycle 12 and opposite pulsations 13 are conducted at a correspondingly rapid rate, the moisture in the paper can be more easily balanced locally and the quality of dampening remains accordingly acceptable. In the illustration, material web 8 runs perpendicular to the illustration along a Z-axis which is not shown. In this case, application nozzles 6 are each part of a dampening device 1, which includes a proportional valve 2 which is not shown. In the illustrated method, cleaning cycle 12 is conducted by a dampening device 1, with adjacent dampening devices 1 performing an opposite pulsation 13.

### COMPONENT IDENTIFICATION LISTING

1 Dampening device
2 proportional valve
3 electromagnetic force transmitter
4 resetting force transmitter
5 control unit
6 application nozzle
7 application orifice
8 material web
9 control range
10 valve body
11 target value
12 cleaning cycle
13 opposite pulsation

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for at least one of regulating and controlling at least one dampening device suitable for dampening a material web, the method comprising the steps of:
providing that the dampening device includes a valve which includes at least one electromagnetic force transmitter, a reset force transmitter, a valve body, the dampening device further including a control unit and an application nozzle; and
performing, by the dampening device, a cleaning cycle, the valve being a proportional valve, the proportional valve pulsing about a set target value, a deviation from the set target value occurring by way of a timing such that the deviation from the set target value results, the deviation being at least one of a positive deviation and a negative deviation.

2. The method according to claim 1, wherein the proportional valve is configured for being opened and closed at least partially and pulsating rapidly about the set target value, wherein the deviation from the set target value lasts less than 0.3 seconds, and the proportional valve is configured for pulsating repeatedly, wherein the material web is a paper web, a cardboard web, or a fibrous web.

3. The method according to claim 2, wherein the deviation from the set target value lasts less than 0.1 seconds.

4. The method according to claim 1, wherein the method includes providing at least two of the dampening device each of which is at least one of controlled and adjusted, wherein a respective one of the dampening device that pulsates in the cleaning cycle is arranged adjacent to at least one other of the dampening device which is configured for performing a pulsation in an opposite direction.

5. The method according to claim 4, wherein the method includes providing more than three of the dampening device.

6. The method according to claim 4, wherein the pulsation in the opposite direction exhibits only half an amplitude or a time duration of the deviation from the set target value.

7. The method according to claim 1, wherein at least one of the cleaning cycle and a pulsating is performed at a time (a) when the material web of reduced quality is being produced, or (b) when a machine for producing the material web is in a specific operating state.

8. The method according to claim 1, wherein when the proportional valve is pulsing the proportional value is performing a pulsation, wherein at least one of the cleaning cycle and the pulsation deviates only in one direction from the set target value, wherein at least one of the cleaning cycle and the pulsation can also be started when the proportional valve is fully closed or fully open.

9. A dampening device suitable for dampening a material web, the dampening device comprising:
a valve including at least one electromagnetic force transmitter, a reset force transmitter, a valve body;
a control unit; and
an application nozzle, the valve being a proportional valve and having a control range, the valve being configured for enabling the control range to be set to a target value in at least 16 steps, the dampening device, by way of the control unit, being configured for performing at least one of a cleaning cycle and a pulsation such that the proportional valve pulses about the target value, a deviation from the target value occurring by way of a timing such that the deviation from the target value results, the deviation being at least one of a positive deviation and a negative deviation.

10. The dampening device according to claim 9, wherein the valve body of the proportional valve traverses a distance of less than 5 mm from closed to open, the valve being configured for enabling the control range to be set to a target value in at least 100 steps.

11. The dampening device according to claim 10, wherein the distance is less than 2 mm.

12. The dampening device according to claim 9, wherein the electromagnetic force transmitter is configured to fully open or fully close the proportional valve from any target value in a time of less than 0.3 seconds.

13. The dampening device according to claim 12, wherein the time is less than 0.1 seconds.

14. The dampening device according to claim 9, wherein the electromagnetic force transmitter is configured to adjust the proportional valve to any target value in a time of less than 0.3 seconds.

15. The dampening device according to claim 9, further comprising an application orifice, wherein the proportional valve is directly followed by the application nozzle or the application orifice, and no additional functional elements are used for pulsation damping.

16. The dampening device according to claim 9, wherein the reset force transmitter of the proportional valve includes a mechanical spring element, a magnetic force transmitter, an electromagnetic force transmitter, or a pneumatic force transmitter.

17. A method of using at least two dampening devices, the method comprising the steps of:
providing that each of the at least two dampening devices is suitable for dampening a material web, each of the at least two dampening devices including respectively:
a valve including at least one electromagnetic force transmitter, a reset force transmitter, a valve body;
a control unit; and
an application nozzle, the valve being a proportional valve and having a control range, the valve being configured for enabling the control range to be set to a target value in at least 16 steps, the dampening device, by way of the control unit, being configured for performing at least one of a cleaning cycle and a pulsation such that the proportional valve pulses about the target value, a deviation from the target value occurring by way of a timing such that the deviation from the target value results, the deviation being at least one of a positive deviation and a negative deviation;
using each of the at least two dampening devices in a method for at least one of regulating and controlling the at least two dampening devices, the method comprising the steps of:
performing, by the at least two dampening devices, the cleaning cycle, the proportional valve pulsing about the target value, the deviation from the target value occurring by way of the timing such that the deviation from the set target value results, the deviation being at least one of the positive deviation and the negative deviation, the at least two dampening devices being arranged over a width of the material web and being configured for applying a plurality of different moistening levels to a plurality of different zones.
